(19) United States
(12) Patent Application Publication
(10) Pub. No.: US 2014/0350729 A1
(43) Pub. Date: Nov. 27, 2014

(54) Combustion Control System

(71) Applicant: Rinnai Corporation, Aichi (JP)

(72) Inventors: Kumiko Okada, Aichi (JP); Naohisa Ogawa, Aichi (JP)

(73) Assignee: Rinnai Corporation, Aichi (JP)

(21) Appl. No.: 14/282,210

(22) Filed: May 20, 2014

(30) Foreign Application Priority Data
May 27, 2013 (JP) 2013-110910

(51) Int. Cl. H02H 7/00; F02D 28/00

(52) U.S. Cl. CPC H02H 7/00; F02D 28/00
USPC 700/275

(57) ABSTRACT

A combustion control system includes: a memory section having stored therein each control data corresponding to each of the models; a switch input section designating setting contents of each model, the setting contents being set for each of the setting items relating to the operation by switched-on/switched-off state of each switch; and an instruction section which instructs the combustion control based on control. The switch input section is provided with at least two groups each being made up of a plurality of switches. An abnormality distinguishing section is provided to distinguish whether on-off states of one group of switches and on-off states of the other group of switches coincide with each other. When the on-off states are distinguished not to coincide with each other, an instruction is given to stop the combustion control. Incomplete combustion is thus prevented even at the time of failure or wrong operation of switches.

### TECHNICAL FIELD

The present invention relates to a combustion control system for performing combustion control of a combustion apparatus such as hot water supply apparatus and the like in which a plurality of models of different operating conditions are available.

### BACKGROUND ART

As this kind of combustion control system, there is known one comprising: a memory section having stored therein each control data corresponding to each model; a switch input section having a plurality of switches manually switched on or off for designating the model by the on-off combination according to the order of arrangement of the switches; and an instruction section for reading out from the memory section the control data corresponding to the model that has been designated by the switch input section, and for instructing to perform the combustion control based on the read-out control data (see, for example, patent document 1).

By the way, the on-off operation of the switches in the switch input section is performed by an operator. Should the switches fail, the on-off combination according to the order of arrangement of the switches will no longer be the one which the operator had in mind, but will be the one which designates the model different from the actual model of the combustion apparatus. Further, there is a possibility, as a result of wrong operation by the operator, that the combination will be obtained according to the order of arrangement designating the model that is different from the actual model of the combustion apparatus. Even under such a situation, the system of the above-described prior art cannot recognize the combination as abnormal. Then, the control is performed by the control data corresponding to a model that is different from an actual model of the combustion apparatus, leading to a possibility of giving rise to incomplete combustion.

### PRIOR ART DOCUMENTS

### Patent Documents

[Patent Document 1] JP-A-2003-232517

### SUMMARY OF THE INVENTION

### Problems to be Solved by the Invention

In view of the above points, this invention has a problem of providing a combustion control system which is arranged to prevent the occurrence of incomplete combustion even if the switch in the switch input section fails or is wrongly operated.

### Means for Solving the Problems

In order to solve the above-described problem, the first invention of this application is a combustion control system for controlling combustion of a combustion apparatus in which a plurality of models of different operating conditions are available. The combustion control system comprises: a memory section having stored therein each control data corresponding to each of the models; a switch input section having a plurality of switches manually switched on or off for designating, by switched-on state or switched-off state of each of the switches, such a setting content of each model as to be set for various setting items relating to operating conditions; and an instruction section for reading out of the memory section the control data complying with the model having a coinciding combination of the setting contents of various setting items that have been designated by the switch input section, and for instructing to perform the combustion control based on the read-out control data. The combustion control system is so arranged as to give rise to incomplete combustion when controlled by control data corresponding to a model that is different from an actual model of the combustion apparatus. The switch input section has at least two groups of switches, each group being made up of a plurality of switches, and the switches belonging to one group and the switches belonging to the other group are used as switches for inputting same setting items. The combustion control system further comprises an abnormality distinguishing section to distinguish whether on-off states of said one group of switches and on-off states of the other group of switches coincide with each other, both groups of switches being used for inputting the same setting items. When the abnormality distinguishing section has distinguished that the on-off states do not coincide with each other, the instruction section instructs to stop the combustion control.

It is to be noted here that, should any one of the switches of one of the groups in the switch input section fail, or should the on-off operation of the switches be wrongly made, there is an extremely small possibility that the other group of switches to be used as switches for inputting the same setting items as said one group of switches also fails or is wrongly operated. There is similarly an extremely small possibility that the on-off states of one group of switches to be used as switches for inputting the same setting items and the on-off states of the other group of switches coincide with each other. And according to the first invention, when the on-off states of one group of switches to be used for inputting the same setting items do not coincide with the on-off states of the other group of switches, the combustion control is stopped. Therefore, incomplete combustion can be prevented from taking place as a result of control by control data which corresponds, due to failure (or going out of order) or wrong operation of any of the switches, to the model different from the actual model of the combustion apparatus.

In addition, the second invention of this application is a combustion control system for controlling combustion of a combustion apparatus in which a plurality of models of different operating conditions are available. The combustion control system comprises: a memory section having stored therein each control data corresponding to each of the models; a switch input section having a plurality of switches manually switched on or off for designating each model by a combination of on or off according to an order of arrangement of the switches; and an instruction section for reading out of the memory section the control data corresponding to the model as designated by the switch input section, and for instructing to perform the combustion control based on the read-out control data. The combustion control system is so arranged as to give rise to incomplete combustion when controlled by control data corresponding to a model that is different from an actual model of the combustion apparatus. The switch input section has at least two groups of switches, each group being made up of a plurality of switches, and the switches belonging to one group and the switches belonging to the other group are used as switches for inputting the models. The combustion control system further comprises an abnormality distinguishing section to distinguish whether on-off combination according to the order of arrangement of said one group of switches and on-off combination according to the order of arrangement of the other group of switches coincide with each other. When the abnormality distinguishing section has distinguished that the on-off combinations according to the order of arrangement do not coincide with each other, the instruction section instructs to stop the combustion control.

Like in the above-described arrangement, it is to be noted here that, should any one of the switches of one of the groups in the switch input section fail, or should the on-off operation of the switches be wrongly made, there is an extremely small possibility that the other group of switches having the same order of arrangement as that of said one group of switches also fail or is wrongly operated. There is similarly an extremely small possibility that the on-off combination of one group of switches according to the order of arrangement of one group of switches and the on-off combination of the other group of switches according to the order of arrangement of the other group of switches coincide with each other. And according to the second invention, when the on-off combination according to the order of arrangement of one group of switches and the on-off combination according to the other group of switches do not coincide with each other, the combustion control is stopped. Therefore, incomplete combustion can be prevented from taking place as a result of control by control data which corresponds, due to failure or wrong operation of any of the switches, to the model different from the actual model of the combustion apparatus.

When each of the switches in the switch input section is each DIP switch of a DIP switch group in which a plurality of DIP switches are disposed in order, if any one of the DIP switches fails, its terminal will be short-circuited with the terminal of the DIP switch that is disposed to lie adjacent thereto. In this manner, the DIP switch that is disposed to lie adjacent to each other will also fail.

As a solution, in case of the first invention in which each of the switches in the switch input section is each DIP switch of a DIP switch group in which a plurality of DIP switches are disposed in order, said one group of switches and the other group of switches to be used for inputting the same setting items as those for said one group of switches shall preferably be disposed so as not to lie adjacent to each other. According to this arrangement, among the switches to be used for inputting the same setting items, in case a DIP switch of one group fails, a DIP switch of the other group can be prevented from failing, too. Therefore, the on-off state of one group of switches to be used as inputting switches for inputting the same setting items ceases to coincide with the on-off state of the other group of switches, and combustion control is stopped, thereby securing safety.

Further, in the second invention, in case each of the switches in the switch input section is each DIP switch of a DIP switch group in which a plurality of DIP switches are disposed in order, said one group of switches and the other group of switches having the same order of arrangement shall preferably be disposed so as not to lie adjacent to each other. According to this arrangement, among the switches having the same order of arrangement, in case a DIP switch of one group fails, a DIP switch of the other group can be prevented from failing, too. Therefore, the on-off combination according to the order of arrangement of said one group of switches and the on-off combination according to the order of arrangement of the other group of switches cease to coincide with each other, and the combustion control is stopped, thereby securing safety.

### BRIEF DESCRIPTION OF THE DRAWINGS

FIG. 1 is a figure to show the arrangement of the combustion control system according to an embodiment of this invention.

FIG. 2 is a table to show the relationship among the model, setting contents, and the switching on or off.

FIG. 3 is a table to show the relationship among the model, setting contents, and the switching on or off according to the second embodiment.

### EMBODIMENTS FOR CARRYING OUT THE INVENTION

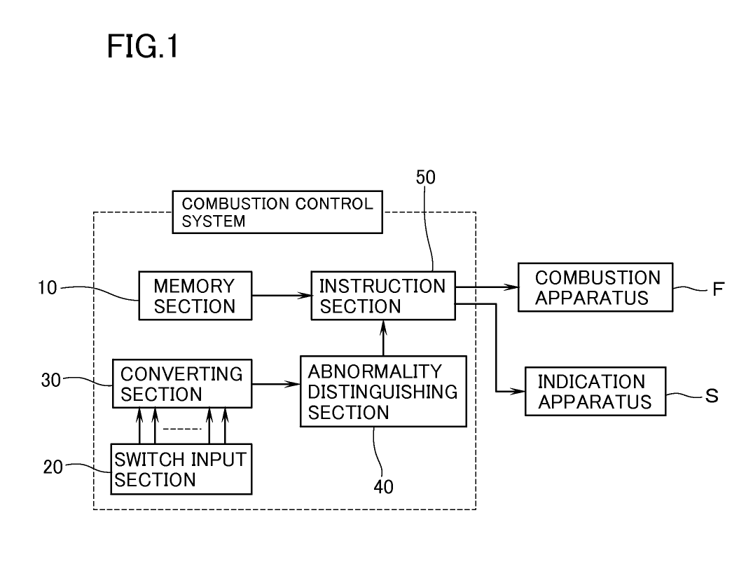

With reference to FIG. 1, the combustion control system according to an embodiment of this invention for performing the combustion control of a combustion apparatus F is provided with a memory section 10, a switch input section 20, a converting section 30, an abnormality distinguishing section 40, and an instruction section 50.

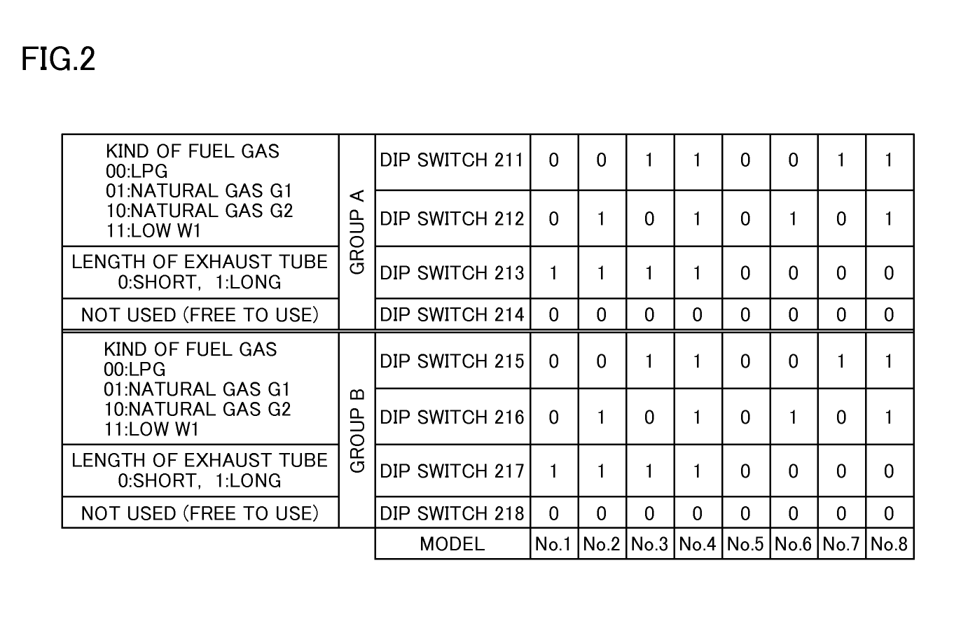

With reference to FIG. 2, as the setting items relating to the operating conditions of the combustion apparatus F, there are two items of kind of fuel gases and the length of exhaust tube (kind of exhaust). As the setting contents of each model in setting the kind of fuel gases, there are four gases of LPG, natural gas 1, natural gas 2, and low Wobbe gas 1. As the setting contents of each model in setting the length of the exhaust tube, there are two lengths of long exhaust and short exhaust. The combustion apparatus F has therefore eight models No. 1-No. 8 of different operating conditions as a result of combination of four setting contents of kind of four fuel gases and two lengths of exhaust tubes.

The memory section 10 holds in memory each of the control data corresponding to respective models. Because the generated calorific value per unit gas volume varies with the kind of fuel gases, the control data includes the data to define the proportional relationship between the required calorific value to be generated at the burner and the electric current of a proportional valve which adjusts the amount of gas. In addition, because the relationship between the number of revolutions of a fan to supply the combustion air and the supplied volume of air vary with the magnitude of the exhaust resistance due to the length of the exhaust tube, the control data includes the data to define the proportional relationship between the electric current to the proportional valve and the number of revolutions of the fan. If the control is performed by the control data corresponding to a model that is different from the one of the actual model of the combustion apparatus F, incomplete combustion takes place.

The switch input section 20 is made up of a DIP switch group having arranged DIP switches 211-218 in order. The DIP switches 211-218 are manually switched on or off. By means of the switched-on state or switched-off state of the DIP switches, such a setting content of each model as to be set for each of the switches is designated. The switch input section 20 is provided with group A which is made up of DIP switches 211-214 and group B which is made up of DIP switches 215-218.

As the input switch for inputting the kind of fuel gases, the DIP switches 211-212 of group A and the DIP switches 215-216 of Group B are used. The DIP switches 211-212 and the DIP switches 215-216 are disposed in a manner not to lie adjacent to each other. Further, as the input switches for inputting the length of exhaust tube, DIP switch 213 of group A and the DIP switch 217 of the group B are used. DIP switch 213 and the DIP switch 217 are disposed so as not to lie adjacent to each other. By the way, in this embodiment the DIP switch 214 of group A and the DIP switch 218 of group B are not used as switches for inputting any of the setting items. In case, for example, intermediate exhausting is added as the setting contents of the length of the exhaust tube so as to make them three in all, the above-described DIP switches can be used as switches for inputting the length of the exhaust tube.

A converting section 30 conducts analog-to-digital (AD) conversion of the signals of the DIP switches 211-218 into 1 when they are switched on, and into 0 when they are switched off.

An abnormality distinguishing section 40 distinguishes as to whether the switched-on state or switched-off state (AD converted signal) of the DIP switches 211, 212 in group A that are used as switches for inputting the kind of fuel gases and the switched-on state or switched-off state of the DIP switches 215, 216 in group B coincide with each other. Also, distinction is made as to whether the switched-on state or switched-off state of the DIP switch 213 in group A coincides with the switched-on state or switched-off state of the DIP switch 217 in group B, both being used as switches for inputting the exhaust lengths.

When the abnormality distinguishing section 40 distinguishes that the switched on-off states coincide with each other, if the signals of the DIP switches 211, 215 are 0, and if the signals of the DIP switches 212, 216 are 0, as shown in FIG. 2, then LPG is read out as the setting contents of the kind of fuel gases. If the signals of the DIP switches 211, 215 are 0, and if the signals of the DIP switches 212, 216 are 1, then natural gas 1 is read out; if the signals of the DIP switches 211, 215 are 1, and if the signals of the DIP switches 212, 216 are 0, then natural gas 2 is read out; and if the signals of the DIP switches 211, 215 are 1, and if the signals of the DIP switches 212, 216 are 1, then low Wobbe gas 1 is read out, respectively, as the setting contents of the kind of fuel gases.

Further, if the signals of the DIP switches 213, 217 are 1, then long exhaust is read out, and if the signals of the DIP switches 213, 217 are 0, then short exhaust is read out, respectively.

The instruction section 50 reads out of the memory section 10 the control data that corresponds to the model coinciding with the combination of the setting contents of the kind of read-out fuel gas and the similarly read-out length of exhaust tube. Combustion control is instructed based on this control data. In concrete, if LPG and long exhaust are read out, control data corresponding to the No. 1 model is read out from the memory section 10; if the natural gas 1 and long exhaust are read out, control data corresponding to No. 2 model is read out; if the natural gas 2 and long exhaust are read out, control data corresponding to No. 3 model is read out; if the low Wobbe gas 1 and long exhaust are read out, the control data corresponding to No. 4 model is read; if LPG and short exhaust are read out, the control data corresponding to No. 5 model is read out; if natural gas 1 and short exhaust are read out, the control data corresponding to No. 6 model is read out; if natural gas 2 and short exhaust are read out, the control data corresponding to No. 7 model is read out; if low Wobbe gas 1 and short exhaust are read out, the control data corresponding to No. 8 model is read out, respectively, from the memory section 10. Combustion control is instructed based on the respective control data.

On the other hand, when the abnormality distinguishing section 40 has distinguished that the on-off states do not coincide with each other, the instruction section 50 instructs the stopping of combustion control. At the same time, the instruction section 50 instructs to report by the indication apparatus S that the on-off states of the DIP switches 211-214 of group A and the on-off states of the DIP switches 215-218 of group B do not coincide with each other. By the way, the indication apparatus S may be disposed in the combustion apparatus F or may be disposed in a remote controller or the like which is away from the combustion apparatus F.

It is to be noted here that, should any one of the DIP switches of one of the groups in the switch input section 20 fails or should the on-off operation of the DIP switches be wrongly made, there is an extremely small possibility that the other group of DIP switches to be used as switches for inputting the same setting items as said one group of DIP switches also fail or are also wrongly operated. There is similarly an extremely small possibility that the on-off states of one group of DIP switches to be used as switches for inputting the same setting items and the on-off states of the other group of DIP switches coincide with each other. According to this embodiment, when the on-off states of the group A of DIP switches 211-214 to be used for inputting the same setting items do not coincide with the on-off states of the other group B of DIP switches 215-218, the combustion control is stopped. Therefore, incomplete combustion can be prevented from taking place as a result of control, due to failure or wrong operation of any of the DIP switches, by control data which corresponds to the model that is different from the actual model of the combustion apparatus F.

By the way, like in this embodiment, in case each of the switches of the switch input section 20 corresponds to each of the DIP switches in a DIP switch group disposed by placing in order a plurality of DIP switches 211-218, if any of the DIP switches fails, the DIP switches that are disposed to lie next to one another will be short-circuited at the terminals of each, thereby striking out of order the DIP switches that are disposed adjacent to each other.

In this embodiment, the DIP switches 211, 212 of group A and the DIP switches 215, 216 of group B are input switches for inputting the kind of fuel gases and are so arranged that they do not lie adjacent to each other. In addition, the DIP switch 213 of group A and DIP switch 217 of group B are for inputting the length of exhaust tube and are so arranged that they do not lie adjacent to each other. As a consequence, in case one group of DIP switches among the switches for inputting the same setting items has failed, the other group of DIP switches can be prevented from failing, too. Therefore, the on-off states of one group of DIP switches to be used for inputting the same setting items and the on-off states of the other group of DIP switches cease to correspond to each other, whereby the combustion control is stopped and safety can be secured.

Descriptions have so far been made of the first embodiment of this invention, but this invention shall not be limited to the above. For example, in the first embodiment, DIP switches 215, 216 are used as the switches for inputting the kind of fuel gases belonging to the group B. Alternatively, DIP switches 216, 217 may also be used. In this case, as the switches for inputting the length of the exhaust pipe belonging to group B, DIP switch 215 may be used.

Further, in the first embodiment as the switches for inputting the kind of fuel gases, there are used DIP switches 211, 212 and DIP switches 215, 216 that are disposed so as not to lie adjacent to the DIP switches 211, 212. Alternatively, there may be used DIP switches 214, 215 that are disposed so as not to lie adjacent to DIP switches 211, 212. In this case, DIP switches 213, 217 may be made as dummy switches. Instead, as switches for inputting the length of the exhaust tube, there may be used a DIP switch 216 and a DIP switch 218 which are disposed in a manner not to lie adjacent to each other. In this manner, the switch input section 20 may be provided with a group made up of DIP switches 211, 212, 216 and a group made up of DIP switches 214, 215, 218.

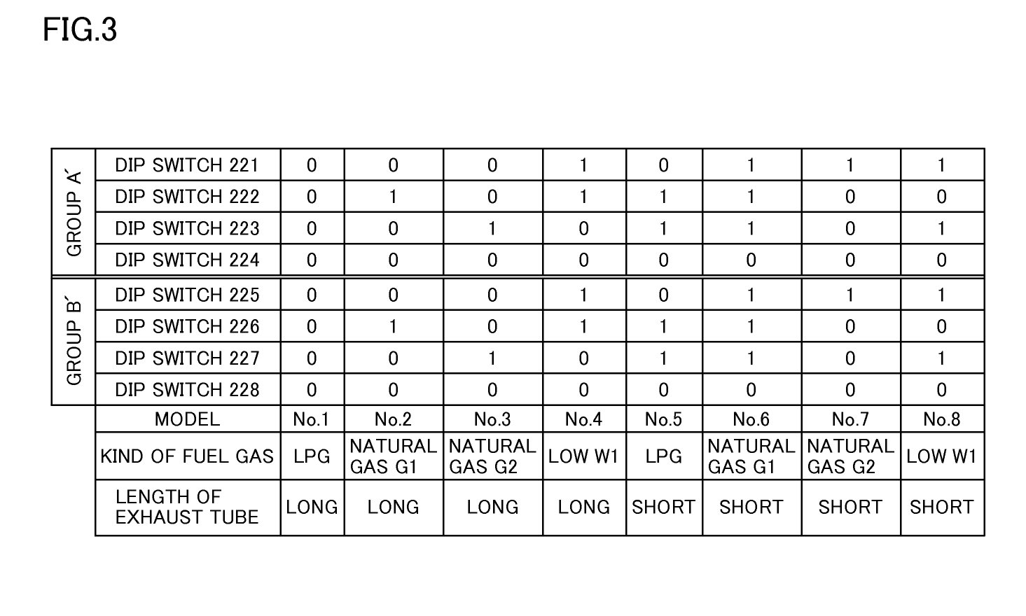

In the first embodiment the switch input section 20 designates, in the on-off state of each of the DIP switches 211-218, the setting contents of each model to be set for each of the setting items of each model relating to the operating conditions. Alternatively, like in the second embodiment as shown in FIG. 3, DIP switches 221-224 of group A′ and DIP switches 225-228 of group B′ may be used respectively as switches for inputting the model. In this manner, the model may be designated by the combination of on-off states according to the order of disposing the DIP switches of each group. In this case, the control data that corresponds to the model as designated by the switch input section 20 may be read out of the memory section 10.

In case any of the DIP switches of one of the groups of the switch input section 20 has failed or in case the on-off operation of the DIP switch is wrongly made, there is extremely small possibility that the DIP switch of the other group having the same order of arrangement of the DIP switch of said one group also fails or the operation is wrongly made. The possibility of also coinciding with each other is extremely small between the combination of on-off states according to the order of arrangement of one group of DIP switches and the combination of on-off states according to the order of arrangement of the other group of DIP switches. Then, according to the second embodiment, when the on-off combination according to the arrangement of one group of DIP switches and the combination of on-off states according to the order of arrangement of the other group of DIP switches do not coincide with each other, the combustion control is stopped. Therefore, incomplete combustion can be prevented from taking place as a result of control by control data, due to failure or wrong operation of any of the DIP switches, which corresponds to the model different from the actual model of the combustion apparatus F.

Further, according to the second embodiment, the DIP switches 221-224 of group A′ and the DIP switches 225-228 of group B′ are disposed so as not to lie adjacent to each other. Therefore, when one group of DIP switches out of the switches whose order of arrangement is the same has failed, the DIP switches of the other group can be prevented from failing. As a result, the on-off combination according to the order of arrangement of one group of DIP switches and the on-off combination according to the order of arrangement of the other group of DIP switches ceases to coincide with each other. The combustion control is thus stopped and safety can be secured. In addition, in order to dispose such that the switches of the same order of arrangement are not adjacent to each other, the switch input section 20 may be provided with a group made up of DIP switches 221, 222, 225, 226 and a group made up of DIP switches 223, 224, 227, 228.

According to the second embodiment, the DIP switches 221-228 of the switch input section 20 will be switched on or off by the combination to designate each model that is determined irrespective of the setting contents of each model. On the other hand, according to the first embodiment, each of the DIP switches 211-218 of the switch input section 20 is set according to the setting items of each model relating to the operating conditions. Therefore, it is easier to compare the setting contents of the actual model with the setting contents to be designated in the on-off states of the DIP switches 211-218 of the switch input section 20. It is therefore helpful in preventing the wrong operation.

In addition, according to the first embodiment, the memory section 10 stores therein each of the control data corresponding to the setting contents of the kind of the fuel gases. Alternatively, control data corresponding to the setting contents of the kind of fuel gases and the control data corresponding to the setting contents of the length of the exhaust tube may be stored separately. In this case, the control data corresponding to the setting contents of the read-out kind of fuel gases and the control data corresponding to the setting contents of the read-out length of the exhaust tube are read out from the memory section 10, so that the combustion control can be instructed based on the data combining both control data.

In addition, the setting items and setting contents relating to the operating conditions of the combustion apparatus F as well as the number thereof are not limited to those described in the first embodiment, but the number of switches depending on the setting contents may be used as the input switches for inputting the same setting items.

Still furthermore, according to the first embodiment, the converting section 30 performs AD conversion of the signals of the DIP switches 211-218 into 1 when they are switched on, and into 0 when they are switched off. Alternatively, AD conversion may be made to convert the signals into 0 when they are switched on and into 1 when they are switched off.

| | |
|---|---|
| F ... combustion apparatus | 10 ... memory section |
| 20 ... switch input section | 40 ... abnormality distinguishing |
| section | 50 ... instruction section |

What is claimed is:

1. A combustion control system for controlling combustion of a combustion apparatus in which a plurality of models of different operating conditions are available, the combustion control system comprising:
a memory section having stored therein each control data corresponding to each of the models;
a switch input section having a plurality of switches manually switched on or off for designating, by switched-on state or switched-off state of each of the switches, such a setting content of each model as to be set for various setting items relating to operating conditions;
an instruction section for reading out from the memory section the control data complying with the model having a coinciding combination of the setting contents of various setting items that have been designated by the switch input section, and for instructing to perform the combustion control based on the read-out control data,
the combustion control system possibly giving rise to incomplete combustion when controlled by control data corresponding to a model that is different from an actual model of the combustion apparatus,
wherein the switch input section has at least two groups of switches, each group being made up of a plurality of switches, and the switches belonging to one group and the switches belonging to the other group are used as switches for inputting same setting items;
wherein the combustion control system further comprises an abnormality distinguishing section to distinguish whether on-off states of said one group of switches and on-off states of the other group of switches coincide with each other, both groups of switches being used for inputting the same setting items, and
wherein, when the abnormality distinguishing section has distinguished that the on-off states do not coincide with each other, the instruction section instructs to stop the combustion control.

2. A combustion control system for controlling combustion of a combustion apparatus in which a plurality of models of different operating conditions are available, the combustion control system comprising:
a memory section having stored therein each control data corresponding to each of the models;
a switch input section having a plurality of switches manually switched on or off for designating each model by a combination of on or off according to an order of arrangement of the switches,
an instruction section for reading out from the memory section the control data corresponding to the model as designated by the switch input section, and for instructing to perform the combustion control based on the read-out control data,
the combustion control system possibly giving rise to incomplete combustion when controlled by control data corresponding to a model that is different from an actual model of the combustion apparatus,
wherein the switch input section has at least two groups of switches, each group being made up of a plurality of switches, and the switches belonging to one group and the switches belonging to the other group are used as switches for inputting the models;
wherein the combustion control system further comprises an abnormality distinguishing section to distinguish whether on-off combination according to the order of arrangement of said one group of switches and on-off combination according to the order of arrangement of the other group of switches coincide with each other; and
wherein, when the abnormality distinguishing section has distinguished that the on-off combinations according to the order of arrangement do not coincide with each other, the instruction section instructs to stop the combustion control.

3. The combustion control system according to claim 1, wherein each of the switches in the switch input section is each DIP switch of a DIP switch group in which a plurality of DIP switches are disposed in order, and
wherein said one group of switches and the other group of switches to be used for inputting the same setting items as those for said one group of switches are disposed so as not to lie adjacent to each other.

4. The combustion control system according to claim 2, wherein each of the switches in the switch input section is each DIP switch of a DIP switch group in which a plurality of DIP switches are disposed in order, and
wherein said one group of switches and the other group of switches having the same order of arrangement are disposed so as not to lie adjacent to each other.
